(19) United States
(12) Patent Application Publication
(10) Pub. No.: US 2026/0110821 A1
(43) Pub. Date: Apr. 23, 2026

(54) Compound Flood Event Impact Forecasting

(71) Applicant: Clearview Land Design, P.L., Tampa, FL (US)

(72) Inventor: Matthew Goolsby, Tampa, FL (US)

(73) Assignee: Clearview Land Design, P.L., Tampa, FL (US)

(21) Appl. No.: 19/367,182

(22) Filed: Oct. 23, 2025

Related U.S. Application Data
(60) Provisional application No. 63/710,738, filed on Oct. 23, 2024.

(51) Int. Cl. G01W 1/10; G01W 1/14; G06T 17/05

(52) U.S. Cl. CPC G01W 1/10; G01W 1/14; G06T 17/05

(57) ABSTRACT

Systems, devices, computer-implemented methods, and/or computer program products that facilitate impact forecasting for compound flood events. In one implementation, a computer-implemented method includes dynamically driving an inundation model with forecast data to generate hazard data that characterizes inundation of a geographic area by a compound flood event induced by multiple flood mechanisms. The forecast data is output by multiple models with each model being configured to simulate a process corresponding to a different flood mechanism among the multiple flood mechanisms. The computer-implemented method also includes classifying, by an outcome model, a subset of assets within an asset inventory as impacted assets using the hazard data. The computer-implemented method further includes generating, by the outcome model, impact data for the compound flood event based on the hazard data and structure data that characterizes attributes of the impacted assets.

### CROSS-REFERENCE TO RELATED APPLICATIONS

The present application claims priority to U.S. Provisional Patent Application No. 63/710,738, filed on Oct. 23, 2024, the content of which is incorporated herein by reference in its entirety for all purposes.

### BACKGROUND

Compound flood events generally occur when multiple flood mechanisms interact to inundate a particular geographic area. For example, a compound flood event may occur in a coastal geographic area when one or more inland hydrologic processes (e.g., streamflow, riverine discharge, and/or rainfall-runoff) interact with one or more oceanic processes (e.g., storm surge, tides, and/or waves) to inundate the coastal geographic area. Complex (e.g., nonlinear) interactions between different flood mechanisms may reduce forecasting accuracy for compound flood events and associated impacts.

### SUMMARY

Various implementations disclosed herein relate to techniques for implementing compound flood event impact forecasting. In one implementation, a computer-implemented method includes dynamically driving an inundation model with forecast data to generate hazard data that characterizes inundation of a geographic area by a compound flood event induced by multiple flood mechanisms. The forecast data is output by multiple models with each model being configured to simulate a process corresponding to a different flood mechanism among the multiple flood mechanisms. The computer-implemented method also includes classifying, by an outcome model, a subset of assets within an asset inventory as impacted assets using the hazard data. The computer-implemented method further includes generating, by the outcome model, impact data for the compound flood event based on the hazard data and structure data that characterizes attributes of the impacted assets.

In another implementation, non-transitory computer-readable medium has program code stored thereon. The program code is executable by one or more processing devices for performing operations. The operations include causing an inundation model to generate hazard data that characterizes inundation of a geographic area by a compound flood event induced by multiple flood mechanisms using input data that represents the multiple flood mechanisms as transient conditions. The operations also include causing an outcome model to generate impact data for the compound flood event using the hazard data and structure data that characterizes attributes of assets within the geographic area. The operations further include generating content that represents a map of the geographic area using the hazard data and the impact data. The operations also include causing a display to present the content, wherein the display is operatively coupled to the one or more processing devices.

In another implementation, a system includes a memory that stores computer-executable components and a processor that executes the computer-executable components stored in the memory. The computer-executable components include an inundation model, an impact model, and a post-processing service. The inundation model generates hazard data using input data corresponding to multiple flood mechanisms. The hazard data characterizes inundation of a geographic area by a compound flooding event induced by the multiple flood mechanisms. The impact model generates impact data for the compound flood event using the hazard data and structure data that characterizes attributes of assets within the geographic area. The post-processing service generates content that represents a map of the geographic area using the hazard data and the impact data. Different layers of the content reference different datasets that express spatial locations differently.

### BRIEF DESCRIPTION OF THE DRAWINGS

Aspects of the present disclosure are described in detail below with reference to the attached drawing figures, wherein:

FIG. 1 is a block diagram illustrating an example operating environment that is suitable for implementing aspects of the present disclosure;

FIG. 2 illustrates example content representing a map of a geographic area, in accordance with aspects of the present disclosure;

FIG. 3 illustrates an exploded view of example content representing a map of a geographic area, in accordance with aspects of the present disclosure;

FIG. 4 illustrates an example mesh or grid representation of a geographic area, in accordance with aspects of the present disclosure;

FIG. 5 illustrates example content representing a map of a geographic area with water surface elevation data, in accordance with aspects of the present disclosure;

FIG. 6 illustrates example content representing a map of a geographic area with hazard data, in accordance with aspects of the present disclosure;

FIG. 7 illustrates example content representing a map of a geographic area with impact data, in accordance with aspects of the present disclosure;

FIG. 8 illustrates an example graphical user interface (GUI) with content representing a map of a geographic area, in accordance with aspects of the present disclosure;

FIG. 9 is a flow diagram illustrating an example method of compound flood event impact forecasting, in accordance with aspects of the present disclosure;

FIG. 10 is a flow diagram illustrating another example method of compound flood event impact forecasting, in accordance with aspects of the present disclosure; and

FIG. 11 is a block diagram illustrating an example computer system that is suitable for implementing aspects of the present disclosure.

### DETAILED DESCRIPTION

The present disclosure describes particular embodiments and their detailed construction and operation. The embodiments described herein are set forth by way of illustration only and not limitation. Those skilled in the art will recognize, considering the teachings herein, that there may be a range of equivalents to the exemplary embodiments described herein. Most notably, other embodiments are possible, variations can be made to the embodiments described herein, and equivalents to the components, parts, or steps that make up the described embodiments may exist. For the sake of clarity and conciseness, certain aspects of components or steps of certain embodiments are presented without undue detail where such detail would be apparent to those skilled in the art considering the teachings herein and/or where such detail would obfuscate an understanding of more pertinent aspects of the embodiments.

As described above, complex (e.g., nonlinear) interactions between different flood mechanisms may reduce forecasting accuracy for compound flood events and associated impacts. Various approaches to forecasting compound flood events have attempted to tackle such challenges by using static modeling techniques. Static modeling techniques generally involve time-independent simulation of a compound flood event. Simulations implemented with static modeling techniques may be characterized as time-independent because static models are driven by input data representing different flood mechanisms as steady-state conditions. Such simulations may also be characterized as time-independent because forecasts output by static models provide a snapshot of a compound flood event at a specific time. Forecasts output by static models generally lack any information regarding how a compound flood event evolves over time. Static modeling techniques are generally computationally efficient because simulating compound flood events without accounting for temporal variations may reduce model size and/or complexity. While computationally efficient, static modeling techniques are generally unable to evaluate input data that represents different flood mechanisms as transient conditions. Static modeling techniques are also generally unable to incorporate feedback from ongoing simulations (e.g., parallel simulations) and/or new observations to calibrate compound flood event forecasts.

Aspects of the present disclosure relate to dynamic modeling techniques for impact forecasting of compound flood events. Dynamic modeling techniques generally involve time-dependent simulation of a compound flood event. Simulations implemented using dynamic modeling techniques may be characterized as time-dependent because dynamic models are driven by input data representing different flood mechanisms as transient conditions. Such simulations may also be characterized as time-dependent because forecasts output by dynamic models adapt to changing conditions of a compound flood event at a specific time.

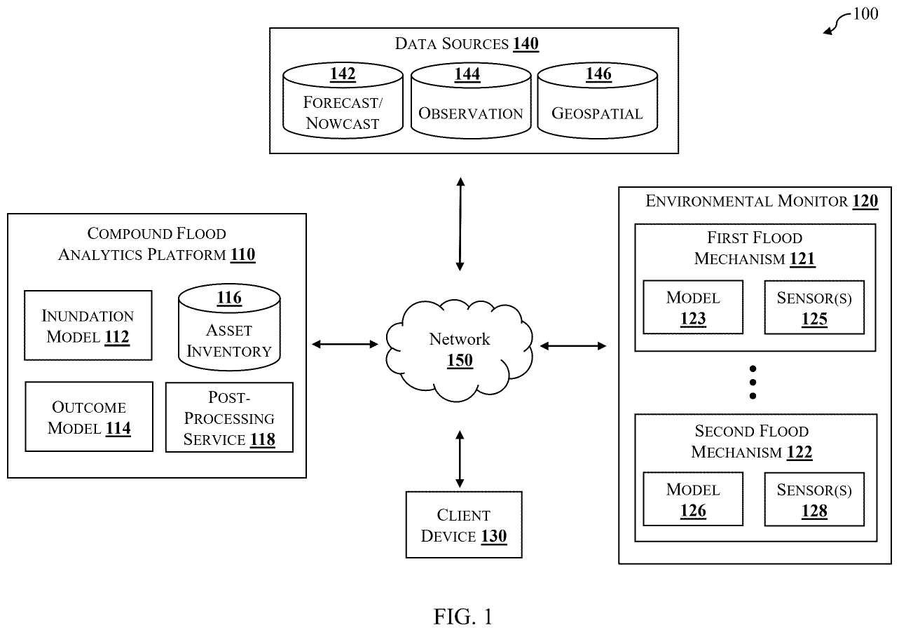

With the foregoing in mind, FIG. 1 is a block diagram that illustrates an example operating environment, generally designated “100,” for implementing aspects of the present disclosure. The operating environment 100 includes a Compound Flood Analytics (CFA) platform 110, an environmental monitor system 120, a client device 130, and one or more data sources 140. Client device 130 generally represents an electronic or computing device that may be configured to interact with one or more users and/or other computing devices. For example, the client device 130 may include a desktop computer, a laptop, a tablet, a smart phone, or other computing devices. FIG. 1 depicts the various computing devices as communicating with each other via one or more networks (e.g., network 150) that may include any combination of public or private networks with any combination of wired or wireless links for exchanging or transferring data between such computing devices. Examples of networks that are suitable for implementing network 150 include: a local area network (LAN), wide area network (WAN), a cellular network, the Internet, and the like.

Within operating environment 100, CFA platform 110 may generally represent an example of one or more components or a system implemented as program code or processor-executable instructions on one or more computer devices in one or more physically distinct locations to implement or perform various aspects of the present disclosure. CFA platform 110 includes an inundation model 112, an outcome model 114, an asset inventory database 116, and a post-processing service 118.

Inundation model 112 generally represents a computational model configured to implement time-dependent simulation of a compound flood event by providing hazard data as output using observation data, forecast data, and/or nowcast data corresponding to multiple flood mechanisms received as input. Hazard data generally characterizes a spatial and/or temporal extent of inundation within a geographic area related to multiple flood drivers. Observation data includes real-time or near real-time sensor data generated by various sensors of environmental monitor 120 for multiple flood mechanisms. Forecast data and/or nowcast data is output by multiple models of environmental monitor 120 that are each configured to simulate a process corresponding to a different flood mechanism among the multiple flood mechanisms. In one implementation, inundation model 112 may be implemented using the Hydrologic Engineering Center River Analysis System (HEC-RAS) model. In one implementation, inundation model 112 may be implemented using the Environmental Protection Agency (EPA) Stormwater Management Model version 5 (SWMM5).

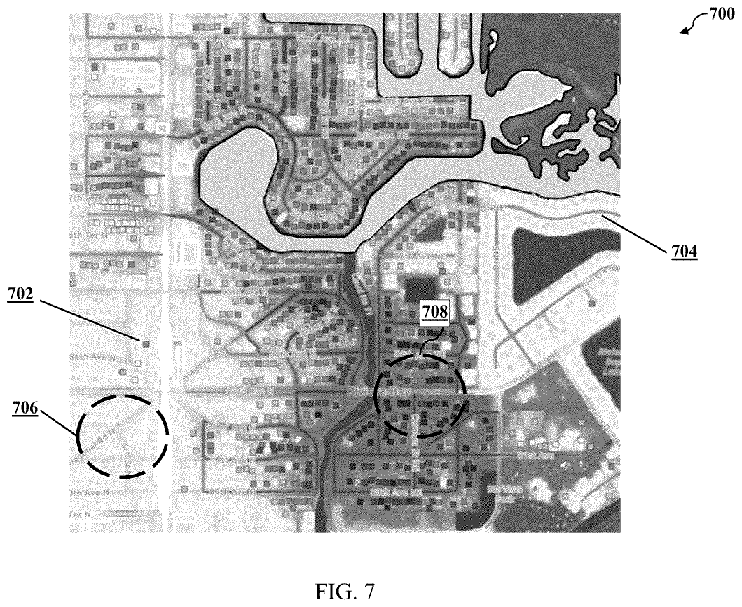

Outcome model 114 generally represents a computational model configured to implement time-dependent simulation of a compound flood event by providing impact data as output using hazard data generated by inundation model 112 received as input. Impact data generally represents forecast adverse effects of a compound flood event within a geographic area that are expressed in terms of asset degradation, debris accrual, and/or recovery time. As discussed below in greater detail with respect to FIG. 7, impact data generated by outcome model 114 can include a depth and/or duration of inundation for assets such as roads in a geographic area. For example, impact data generated by outcome model 114 can include a depth of inundation for a given asset when hazard data generated by inundation model 112 represents a forecast water level that substantially equals or exceeds elevation data of the given asset during at least one forecast interval. Another example, impact data generated by outcome model 114 can include a duration or temporal overlap of inundation for the given asset that characterizes how long the given asset remains subject to inundation related to a compound flood event. In one implementation, outcome model 114 implements the Hazus flood model methodology or uses one or more hazard damage functions stored in a Hazus dataset or library managed by the Federal Emergency Management Administration (FEMA).

Asset inventory database 116 includes structure data for assets in a geographic area, such as building assets, thoroughfare assets, and the like. Structure data generally characterizes attributes of assets in a geographic area. Example attributes of buildings include: building-subtype, such as residential-subtype (e.g., single-family detached, single-family attached, multi-family, etc.), commercial-subtype (e.g., office, retail, hotel, etc.), industrial-subtype (e.g., manufacturing, warehouse, distribution, etc.), and institutional-subtype (e.g., hospital, government facility, religious facility, etc.); construction material, such as wood, brick, concrete, and the like; location data (e.g., address, building footprint, geographic coordinates, etc.); and other distinguishing attributes of buildings. Example attributes of thoroughfare assets include: thoroughfare-subtype (e.g., road, highway, avenue, etc.): number of lanes; location data (e.g., end point locations, routing information, intersection point between two or more thoroughfares, etc.); construction materials, such as asphalt, concrete, gravel, and the like; and other distinguishing attributes of thoroughfares. In one implementation, asset inventory database 116 includes a custom asset inventory dataset managed by a user of client device 130 on behalf of a specific entity, such as a commercial entity or a government entity. In one implementation, asset inventory database 116 includes furniture, fixtures and equipment (FF&E) data that characterizes various chattel or moveable property that has no permanent connection to an asset in the geographic area, such as appliances, commercial inventory, equipment, and other chattel or moveable property.

Post-processing service 118 is configured to generate various content for presentation on a display associated with an electronic device (e.g., CPA platform 110 and/or client device 130), as described in greater detail below. Post-processing service 118 is also configured to generate various derived data using existing data stored on data sources 140 and/or generated by inundation model 112, outcome model 114, and/or environmental monitor 120, as described in greater detail below.

Environmental monitor 120 generally represents any combination of government or private entities that operate services that provide various data characterizing a state of different environmental or atmospheric conditions, such as the National Oceanic and Atmospheric Administration (NOAA), the European Centre for Medium-Range Weather Forecasts (ECMWF), the European Environment Agency (EEA), and the like. Environmental monitor 120 includes a first flood mechanism (FFM) monitor 121 and a second flood mechanism (SFM) monitor 122 that are each configured provide data characterizing a different flood mechanism among multiple flood mechanisms that contribute to a compound flood event.

FFM monitor 121 includes a model 123 configured to simulate a process corresponding to a first flood mechanism, such as an inland hydrologic process (e.g., streamflow, riverine discharge, and/or rainfall-runoff). Model 123 generates forecast data and/or nowcast data that estimates or predicts a future state of the process corresponding to the first flood mechanism. In one implementation, model 123 may be implemented using the National Water Model (NWM) operated by the National Weather Service (NWS) in the United States. FFM monitor 121 also includes one or more sensors 125 that generate observation data that measures a state of the process corresponding to the first flood mechanism. In one implementation, the one or more sensors 125 may be implemented using stream gauges operated by the United States Geological Survey (USGS).

SFM monitor 122 includes a model 126 configured to simulate a process corresponding to a second flood mechanism, such as an oceanic process (e.g., storm surge, tides, and/or waves). Model 126 generates forecast data and/or nowcast data that estimates or predicts a future state of the process corresponding to the second flood mechanism. In one implementation, model 126 may be implemented using Advanced Circulation Model (ADCIRC), Sea, Lake, and Overland Surges from Hurricanes (SLOSH) model, Simulating Waves Nearshore (SWAN) model, and the like. In one implementation, model 126 may be driven by surge forecast data and/or tide forecast data generated by an oceanic process forecasting system such as the two-dimensional (2D) Surge and Tide Operational Forecasting System (STOFS-2D Global) operated by NOAA. In one implementation, model 126 may be driven by atmospheric data generated by the Global Forecast System (GFS) operated by NOAA. In one implementation, forecast data and/or nowcast data generated by model 126 can serve as tidal boundary condition data within a simulation domain of inundation model 112. SFM monitor 122 also includes one or more sensors 128 that generate observation data that measures a state of the process corresponding to the second flood mechanism. In one implementation, the one or more sensors 128 may be implemented using tidal gauges operated by NOAA.

Data sources 140 generally represent remote memory resources accessible by various computing devices in operating environment 100 via network 150. Data sources 140 may include any combination of a network attached storage (NAS), a storage area network (SAN), a cloud-based storage service, or any other suitable remote memory resource. Data sources 140 include a forecast/nowcast database 142, an observation database 144, and a geospatial database 146. Forecast/nowcast database 142 includes forecast data and/or nowcast data generated by models 123 and 126 of environmental monitor 120 for a geographic area. In one implementation, forecast/nowcast database 142 also includes precipitation forecast data, precipitation nowcast data, evaporation forecast data, and/or evaporation nowcast data for a geographic area generated by one or more models, such as the Weather Research and Forecasting (WRF) model, the GFS model, and the like. In one implementation, forecast/nowcast database 142 includes forecast data and/or nowcast data generated by a blend of models, such as a national-level blend of models, regional-level blend of models, state-level blend of models, city-level blend of models, and the like.

Observation database 144 includes observation data generated by sensors 125 and 128 of environmental monitor 120 for a geographic area. In one implementation, observation data in observation database 144 may be updated on a real-time or near real-time basis. In one implementation, observation data in observation database 144 includes water level data provided, in the United States, by the USGS, a regional-level agency, a state-level environmental agency such as the Florida Department of Environmental Protection (FDEP), a water management district, a city-level environmental agency, and the like. In one implementation, observation database 144 includes precipitation observation data for a geographic area generated by a sensor (e.g., a rain gauge) of a weather station associated with environmental monitor 120. In one implementation, observation database 144 includes precipitation observation data (e.g., hourly rainfall data) from the Multi-Radar Multi Sensor (MRMS) Quantitative Precipitation Estimation (QPE) system operated by the NWS in the United States. Geospatial database 146 includes geographic data that characterizes attributes of features in a geographic area, such as surface roughness, land use, crop type, soil properties, impervious cover, aquifer properties, water table elevation, elevation data (e.g., ground surface bathymetry and/or ground surface topography), and other distinguishing attributes of features in the geographic area. In one implementation, geospatial database 146 includes geospatial datasets managed by USGS. In one implementation, elevation data in geospatial database 146 includes a digital elevation model (DEM) of the geographic area. In one implementation, the DEM of the geographic area includes ground surface elevation data obtained using any combination of Light Detection and Ranging (LiDAR) sensors, Radio Detection and Ranging (RADAR) sensors, terrestrial image sensors, and satellite image sensors.

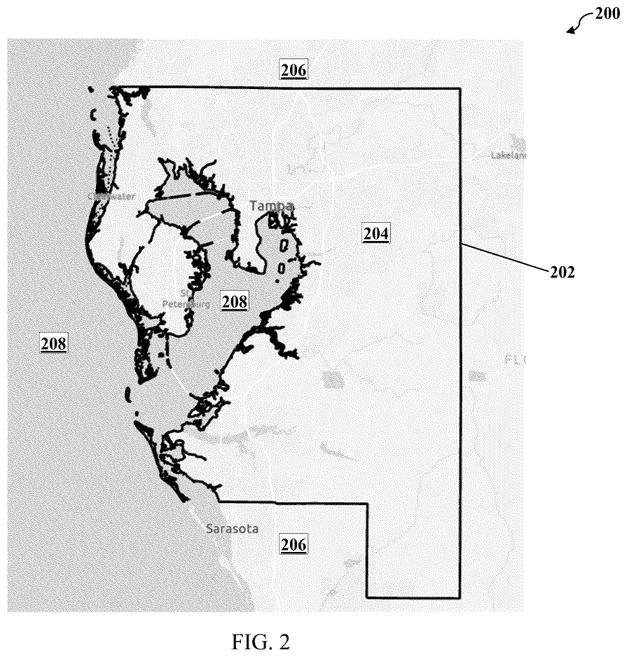

FIG. 2 illustrates example content 200 representing a map of a geographic area, in accordance with aspects of the present disclosure. In this example, the geographic area is the Tampa Bay area of Florida. Content 200 generally includes a basemap or reference map of the geographic area that provides spatial context for various data processed by CFA platform 110. Examples of such data processed by CFA platform 110 includes: observation data, forecast data, nowcast data, hazard data, impact data, geospatial data, and user input data. Additional spatial context can be provided by labels associated with distinct features in the geographic area. In this example, content 200 includes labels associated with different cities in the Tampa Bay area, such as Tampa, Clearwater, St. Petersburg, Sarasota, and Lakeland. In other examples, content 200 includes labels associated with other distinct features in a given geographic area, such as airports, lakes, mountains, stadiums, government offices, zoos, countries, beaches, and the like.

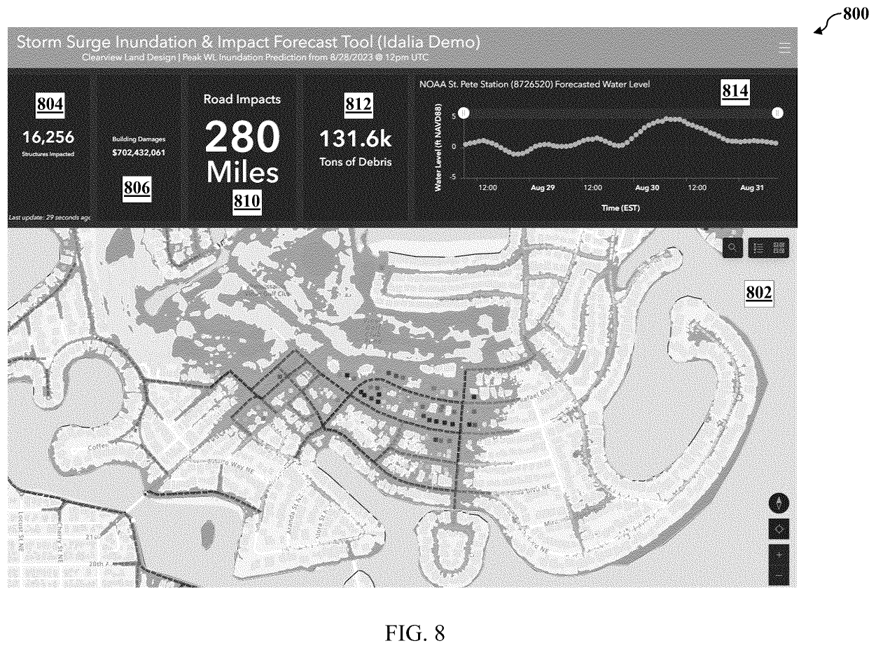

Post-processing service 118 may generate a graphical user interface (e.g., dashboard 800 of FIG. 8) with content 200 for presentation on a display associated with an electronic device (e.g., CPA platform 110 and/or client device 130). User input may be received by post-processing service 118 via the graphical user interface to interact with the map of the geographic area represented by content 200.

For example, post-processing service 118 may receive user input to change an extent of content 200 included in the graphical user interface presented on the display. The extent of content 200 included in the graphical user interface presented on the display generally corresponds to a view of the map represented by content 200. In this example, post-processing 118 may change the extent of content 200 included in the graphical user interface to provide an updated view of the map represented by content 200 based on the user input. The updated view of the map represented by content 200 may include a larger geographic area. In this example, the larger geographic area may encompass other cities in Florida (e.g., Naples, Orlando, and the like) or Florida at large. The updated view of the map represented by content 200 may also include a smaller geographic area. In this example, the smaller geographic area may encompass a subset of cities in the Tampa Bay area of Florida that excludes one or more cities in the Tampa Bay area.

Another example, post-processing service 118 may receive user input to define a polygon shape 202 within the map of the geographic area represented by content 200. In this example, polygon shape 202 bounds an inland area 204 of the geographic area in content 200. Polygon shape 202 also excludes both an inland area 206 and an offshore area 208 of the geographic area in content 200.

Such user input received by post-processing service 118 may also control time-dependent simulations of compound flood events by one or more of inundation model 112 and outcome model 114. As described in greater detail below, an area of interest (AoI) controls a geometry or domain of the respective time-dependent simulations implemented by inundation model 112 and outcome model 114. For example, inundation model 112 may be dynamically driven by input data corresponding to a portion of the geographic area bounded by an AoI. In this example, inundation model 112 may output hazard data for the portion of the geographic area in content 200 that is bounded by the AoI based on that input data. Another example, outcome model 114 may be dynamically driven by the output hazard data that inundation model 112 outputs for the portion of the geographic area in content 200 that is bounded by the AoI. In this example, outcome model 114 may output impact data for the portion of the geographic area in content 200 that is bounded by the AoI based on the hazard data output by inundation model 112. In some implementations, a view of the map represented by content 200 may define an AoI. In other implementations, a polygon shape such as polygon shape 202 may define an AoI.

While the foregoing implementation describes user input being received via the graphical user interface, post-processing service 118 may receive user input via other user input mechanisms associated with the electronic device in other implementations. Examples of such other user input mechanisms associated with the electronic device include physical input mechanisms (e.g., a mouse, a physical keyboard, a joystick, a knob, and the like), simulated input mechanisms (e.g., a softkey, a virtual keyboard, and the like), or a combination thereof.

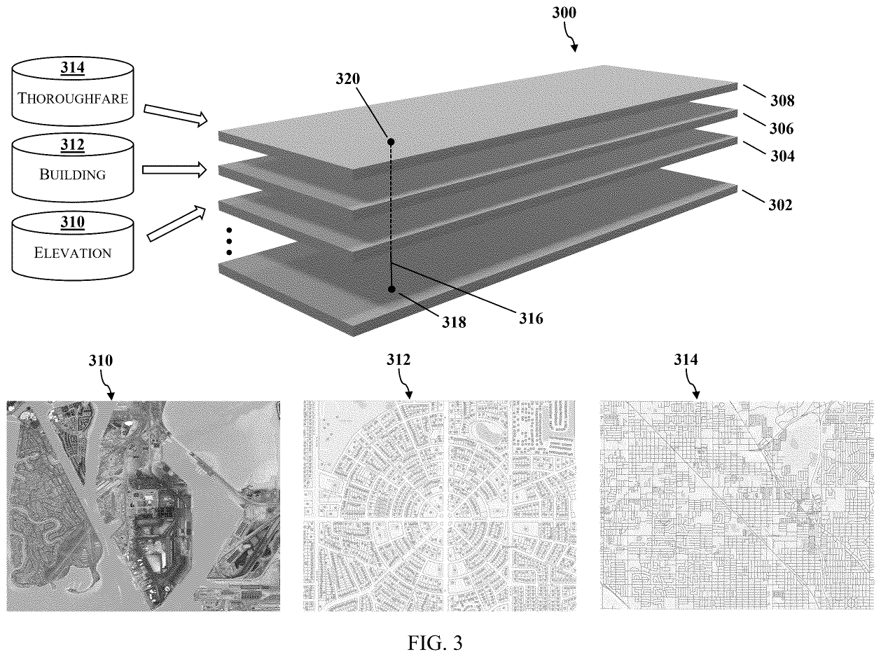

FIG. 3 illustrates an exploded view of example content 300 representing a map of a geographic area, in accordance with aspects of the present disclosure. As seen in the exploded view of FIG. 3, the map of the geographic area represented by content 300 includes a number of distinct layers. Each layer of content 300 generally corresponds to different data regarding the geographic area in content 300. Stated differently, each layer of content 300 generally provides different types of information about the geographic area in content 300. Each layer of content 300 generally references a different source dataset or different subsets of a given source dataset. In one implementation, data regarding the geographic area in content 300 is formatted as raster data or vector data.

In FIG. 3, layer 302 corresponds to a basemap or reference map of the geographic area in content 300 to provide spatial context. For example, the basemap or reference map included in content 200 of FIG. 2 may implement layer 302. Layer 304 references an elevation dataset 310 that includes ground surface elevation data for the geographic area in content 300. Ground surface elevation data corresponding to inland regions of the geographic area generally represents ground surface topography expressed in terms of height relative to a vertical datum (e.g., NAVD88). Ground surface elevation data corresponding to offshore regions of the geographic area generally represents ground surface bathymetry expressed in terms of height relative to a vertical datum (e.g., NAVD88). In one implementation, elevation dataset 310 includes a DEM of the geographic area. In one implementation, the DEM of the geographic area includes ground surface elevation data obtained using any combination of LiDAR sensors, RADAR sensors, terrestrial image sensors, and satellite image sensors. In one implementation, CFA platform 110 retrieves elevation dataset 310 from geospatial database 146.

Layer 306 references a building dataset 312 that includes structure data characterizing attributes of buildings corresponding to the geographic area in content 300. Example attributes of buildings include: building-subtype, such as residential-subtype (e.g., single-family detached, single-family attached, multi-family, etc.), commercial-subtype (e.g., office, retail, hotel, etc.), industrial-subtype (e.g., manufacturing, warehouse, distribution, etc.), and institutional-subtype (e.g., hospital, government facility, religious facility, etc.); construction material, such as wood, brick, concrete, and the like; location data (e.g., address, building footprint, geographic coordinates, etc.); and other distinguishing attributes of buildings. Layer 308 references a thoroughfare dataset 314 that includes structure data characterizing attributes of thoroughfares corresponding to the geographic area in content 300. Example attributes of thoroughfares include: thoroughfare-subtype (e.g., road, highway, avenue, etc.): number of lanes; location data (e.g., end point locations, routing information, intersection point between two or more thoroughfares, etc.); construction materials, such as asphalt, concrete, gravel, and the like; and other distinguishing attributes of thoroughfares. In one implementation, CFA platform 110 retrieves building dataset 312 and/or thoroughfare dataset 314 from asset inventory database 116.

Post-processing service 118 implements data layering operations to generate content 300 by overlaying or projecting one distinct layer of the map represented by content 300 onto another distinct layer. Different layers of content 300 may reference different datasets or data subsets that express spatial locations differently. For example, different layers of content 300 may have different horizontal and/or vertical datums. Another example, one layer of content 300 may have coordinates expressed with reference to a Cartesian coordinate system and another layer of content 300 may have coordinates expressed with reference to a spherical coordinate system.

One aspect of the data layering operations implemented by post-processing service 118 to generate content 300 involves transforming coordinates, a horizontal datum, and/or a vertical datum of a given layer to a common or local geographic coordinate system. A geospatial relationship 316 may exist between point 318 of layer 302 and point 320 of layer 308. For example, point 318 may be a location in the geographic area of the map represented by content 300 that corresponds to an intersection point between two thoroughfares that is identified by point 320. Yet, a dataset or data subset referenced by layer 302 and thoroughfare dataset 314 referenced by layer 308 may express spatial locations differently.

To preserve geospatial relationship 316 between points 318 and 320 in content 300, post-processing service 118 may determine one or more spatial transformations (e.g., translation, rotation, and/or scaling matrix operations) that convert respective coordinates of layers 302 and 308 into a common geographic coordinate system. In one implementation, a geographic coordinate system of layer 302 is defined as the common geographic coordinate system. In this implementation, the one or more spatial transformations convert coordinates of layer 308 into coordinates of layer 302. In one implementation, layers 302 and 308 each have respective geographic coordinate systems that are different than the common geographic coordinate system. In this implementation, the one or more spatial transformations include first and second spatial transforms that convert coordinates of layers 302 and 308, respectively, into the common geographic coordinate system. In one implementation, post-processing service 118 is configured to store such spatial transformations in memory resources (e.g., asset inventory database 116 and/or data sources 140) accessible to CFA platform 110 for subsequent use by CFA platform 110.

Different layers of content 300 may have different spatial resolutions or cell sizes. Values for data referenced by a given layer may be unknown due to differences in spatial resolution between different layers of content 300 and/or within a given layer of content 300. For example, a first layer of content 300 may have a homogenous spatial resolution (e.g., 1-meter spatial resolution) and a second layer of content 300 may have a heterogeneous spatial resolution that varies from a first spatial resolution (e.g., 10-meter spatial resolution) to a second spatial resolution (e.g., a 1000-meter spatial resolution) within the geographic area in content 300. In this example, the homogeneous spatial resolution of the first layer may be higher than both the first and second spatial resolutions of the second layer. Another example, a first layer of content 300 may have a first spatial resolution (e.g., 1-meter spatial resolution) and a second layer of content 300 may have a second spatial resolution (e.g., 10-meter spatial resolution) that is lower than the first spatial resolution.

Another aspect of the data layering operations implemented by post-processing service 118 to generate content 300 involves interpolation where post-processing service 118 estimates or predicts unknown values in data referenced by a given layer of content 300 using known values in that data. In either preceding example, data referenced by the first layer of content 300 may have a known value for a given location of the geographic area in content 300 while data referenced by the second layer may have an unknown value for the given location. Post-processing service 118 may estimate or predict that unknown value by interpolation (e.g., distance weighted interpolation, natural neighbor interpolation, and the like) using known values in the data referenced by the second layer for locations proximate to the given location.

FIG. 3 depicts the map of the geographic area represented by content 300 as including four distinct layers (i.e., layers 302, 304, 306, and 308). In other implementations, the map represented by content 300 may include a higher number (e.g., five) of distinct layers or a lower number (e.g., three) of distinct layers. In FIG. 3, content 300 includes layers 302, 304, 306, and 308 corresponding to a basemap, elevation dataset 310, building dataset 312, and thoroughfare dataset 314, respectively. In other implementations, content 300 may include other layers that each correspond to different data processed by CFA platform 110, such as forecast data, nowcast data, observation data, hazard data, impact data, and other data regarding the geographic area in content 300.

Some layers of content 300 correspond to data (sporadic data) regarding the geographic area in content 300 with locations and attributes that remain substantially unchanged or that are updated on an irregular, aperiodic, and/or sporadic basis. For example, layer 308 corresponds to structure data that characterizes attributes of thoroughfares within the geographic area in content 300. In this example, location data for a given thoroughfare in the geographic area may remain substantially unchanged and attributes such as number of lanes may be updated in thoroughfare dataset 314 on an irregular, aperiodic, and/or sporadic basis. In one implementation, sporadic data corresponding to a layer of content 300 are stored in memory resources (e.g., asset inventory database 116 and/or data sources 140) accessible to CFA platform 110 to improve computational efficiency (e.g., reduce data access and/or processing times).

Some layers of content 300 correspond to data (stream data) regarding the geographic area in content 300 with locations and/or attributes that are updated on a regular, periodic, and/or real-time or near real-time basis. For example, content 300 may include an additional layer (not shown) that corresponds to precipitation observation data for the geographic area in content 300. In this example, rain gauges with static or fixed locations may provide updated values for the precipitation observation data on a real-time or near real-time basis. Another example, content 300 may include an additional layer (not shown) that corresponds to forecast data for a storm event approaching the geographic area in content 300. In this example, a model configured to simulate the storm event may provide updated values for both a forcasted path of the approaching storm event and a forecasted strength or category of the approaching storm event on a periodic or regular basis (e.g., daily, sub-daily, etc.).

In one implementation, CFA platform 110 is configured to support dynamic server-side updates of stream data corresponding to a layer of content 300. In one implementation, a push-based interface is implemented between CFA platform 110 and a source (e.g., environmental monitor 120 and/or data sources 140) of the stream data. In this implementation, the source of the stream data initiates or pushes updates of stream data to CFA platform 110. In one implementation, a pull-based interface is implemented between CFA platform 110 and a source (e.g., environmental monitor 120 and/or data sources 140) of the stream data. In this implementation, CFA platform 110 initiates or pulls updates of stream data from the source of the stream data.

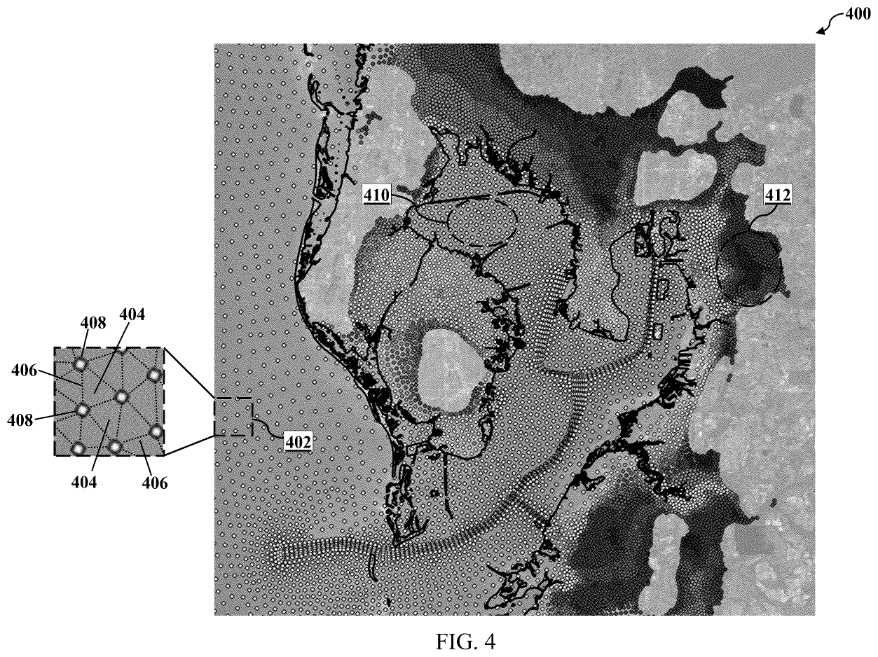

FIG. 4 illustrates an example mesh or grid representation 400 of a geographic area, in accordance with aspects of the present disclosure. CFA platform 110 applies a discretization process to ground surface elevation data (e.g., a DEM in elevation dataset 310 that is referenced by layer 304 of FIG. 3) of the geographic area to generate or build mesh representation 400. That discretization process generally involves CFA platform 110 partitioning the ground surface elevation data of the geographic area in a geographic domain or real-space into a finite number of polyhedron elements in a simulation domain or computational-space of a model (e.g., inundation model 112 and/or outcome model 114 of FIG. 1). For example, region 402 of mesh representation 400 includes a finite number of triangular elements or grid cells 404 that are formed by edges 406 connecting adjacent nodes or vertices 408 within the simulation domain.

FIG. 4 depicts mesh representation 400 as an unstructured mesh representation of the geographic area inasmuch as a density of nodes 408, a length of each edge 406, and/or a size or area of each element 404 varies within the simulation domain. For example, region 402 has a first density of nodes 408 and region 410 of mesh representation 400 has a second density of nodes 408 that is lower than the first density of nodes 408. Another example, region 412 of mesh representation 400 has a third density of nodes 408 that is higher than both the second density of nodes 408 in region 410 and the first density of nodes 408 in region 402. In other implementations, mesh representation 400 may be a structured mesh representation of the geographic area where a density of nodes 408, a length of each edge 406, and/or a size or area of each element 404 remains constant within the simulation domain to form a regular grid.

As described above with reference to FIG. 2, an AoI defined by user input that post-processing service 118 receives via the graphical user interface controls a geometry or domain of the respective time-dependent simulations implemented by models. To that end, the discretization process may involve CFA platform 110 defining an extent for the simulation domain of the model that conforms with an extent of an AoI that user input defines in the geographic domain. Defining an extent for a simulation domain of a model that conforms with an extent of an AoI that user input defines in a geographic domain may reduce consumption of computational resources by time-dependent simulations to improve computational efficiency. Defining an extent for a simulation domain of a model that conforms with an extent of an AoI may also increase forecasting accuracy by dynamically driving a model with input data that is more locally relevant to the AoI.

The discretization process may involve CFA platform 110 defining a number of boundaries for the simulation domain of the model. A boundary of the model generally represents a location where water enters and/or exits the simulation domain due to external factors, such as inland hydrologic processes (e.g., streamflow, riverine discharge, and/or rainfall-runoff), oceanic processes (e.g., storm surge, tides, and/or waves), and meteorologic factors (e.g., precipitation). CFA platform 110 may define a boundary for the simulation domain using a particular polygon (e.g., one or more elements 404), a line (e.g., one or more edges 406), or a particular node 408 of mesh representation 400. For compound flood events, the discretization process may involve CFA platform 110 defining a first boundary (e.g., an inland boundary) and a second boundary (e.g., an oceanic boundary) for the simulation domain of the model. A first boundary generally represents a location where water enters and/or exits the simulation domain due to a first flood mechanism (e.g., an inland hydrologic process). A second boundary generally represents a location where water enters and/or exits the simulation domain due to a second flood mechanism (e.g., an oceanic hydrologic process). CFA platform 110 may configure a first boundary to receive input data related to a first flood mechanism. For example, CFA platform 110 may configure the first boundary to receive input data corresponding to forecast data or nowcast data output by model 123, observation data generated by sensor 125, or a combination thereof. CFA platform 110 may configure a second boundary to receive input data related to a second flood mechanism. For example, CFA platform 110 may configure the second boundary to receive input data corresponding to forecast data or nowcast data output by model 126, observation data generated by sensor 128, or a combination thereof.

CFA platform 110 also parameterizes mesh representation 400 for time-dependent simulation by the model (e.g., inundation model 112 and/or outcome model 114 of FIG. 1). Parameterizing mesh representation 400 for time-dependent simulation generally involves CFA platform 110 determining one or more simulation transformations (e.g., translation, rotation, and/or scaling matrix operations). The one or more simulation transformations define conversions between coordinates in a geographic coordinate system (e.g., a common or local geographic coordinate system) of the geographic domain and coordinates in a simulation coordinate system of the simulation domain. For example, coordinates assigned to a given node 408 of the grid representation 400 in the simulation coordinate system can be mapped to coordinates of a particular point (e.g., points 318 and/or 320 of FIG. 3) in the geographic coordinate system using the one or more simulation transformations. In one implementation, the one or more simulation transformations are stored in memory resources (e.g., asset inventory database 116 and/or data sources 140) accessible to CFA platform 110 for subsequent use by CFA platform 110.

Parameterizing mesh representation 400 for time-dependent simulation also involves CFA platform 110 assigning values to elements 404 or nodes 408 of mesh representation 400 for different hydrological-related and/or hydraulic-related attributes or characteristics of the geographic area using the one or more simulation transformations. For example, CFA platform 110 may assign values of ground surface elevation data to elements 404 or nodes 408 of mesh representation 400 using the one or more simulation transformations. Values of ground surface elevation data that CFA platform 110 assigns to elements 404 or nodes 408 generally correspond to both inland regions and offshore regions of the geographic area. Values of ground surface elevation data assigned to elements 404 or nodes 408 corresponding to inland regions of the geographic area generally represent ground surface topography expressed in terms of height relative to a vertical datum (e.g., NAVD88). Values of ground surface elevation data assigned to elements 404 or nodes 408 corresponding to offshore regions of the geographic area generally represent ground surface bathymetry expressed in terms of height relative to a vertical datum (e.g., NAVD88). Examples of other hydrological-related and/or hydraulic-related attributes or characteristics of the geographic area include: soil type; land use; land cover; and the like.

In one implementation, parameterizing mesh representation 400 for time-dependent simulation also involves CFA platform 110 setting one or more initial conditions for the simulation domain to initialize the model. The one or more initial conditions may include an initial soil saturation level, an initial groundwater level, an initial value for input data related to a first flood mechanism, an initial value for input data related to a second flood mechanism, and the like. CFA platform 110 may set the one or more initial conditions for the simulation domain on a global basis that applies to the simulation domain at large or on a local basis that applies to a subset (e.g., a particular node 408, a particular element 404, and/or a region defined by multiple elements 404) of the simulation domain. CFA platform 110 may set the one or more initial conditions for the simulation domain using one or more of antecedent observation data, current observation data, antecedant forecast data, and antecedent nowcast data. In one implementation, CFA platform 110 retrieves antecedent observation data and/or current observation from one or more of environmental monitor 120 and observation database 144. In one implementation, CFA platform 110 retrieves antecedent forecast data and/or antecedent nowcast data from one or more of environmental monitor 120 and forecast/nowcast database 142.

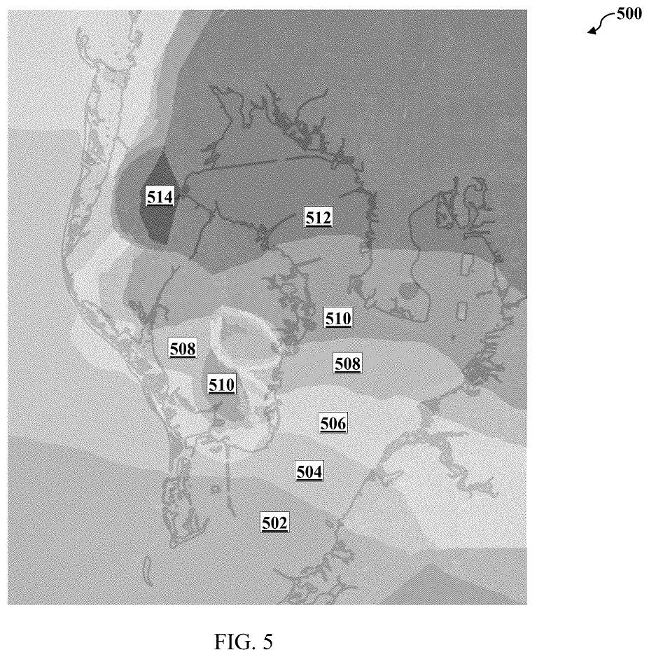

FIG. 5 illustrates example content 500 representing a map of a geographic area with water surface elevation data, in accordance with aspects of the present disclosure. Content 500 generally includes a basemap or reference map of the geographic area to provide spatial context. For example, the basemap included in content 500 may be implemented using the basemap included in content 200 of FIG. 2 and/or layer 302 in content 300 of FIG. 3. Content 500 also includes water surface elevation data generated by inundation model 112 implementing a time-dependent simulation of a compound flood event. Implementing the time-dependent simulation of the compound flood event generally involves CFA platform 110 providing forecast data corresponding to multiple flood drivers and/or observation data as input to inundation model 112. The forecast data corresponding to the multiple flood drivers includes forecast data output by model 123 for a first flood mechanism. The forecast data corresponding to the multiple flood drivers also includes forecast data output by model 126 for a second flood mechanism. CFA platform 110 retrieves the forecast data corresponding to the multiple flood drivers from one or more of environmental monitor 120 and forecast database 142. Inundation model 112 generates water surface elevation data responsive to forecast data corresponding to multiple flood drivers and/or observation data being provided as input. In one implementation, water surface elevation data is output by inundation model 112 and stored as a dataset in memory resources (e.g., asset inventory database 116 and/or data sources 140) accessible to CFA platform 110 for subsequent use by CFA platform 110. In one implementation, water surface elevation data in content 500 is formatted as raster data or vector data. In one implementation, water surface elevation data is intermediate data generated by inundation model 112 within the simulation domain to generate other data output by inundation model 112 such as hazard data.

Water surface elevation data generally represents forecast water surface levels (forecast water levels) within the geographic area for the compound flood event that are expressed in terms of height above a vertical datum (e.g., NAVD88). FIG. 5 shows that the forecast water levels represented by the water surface elevation data of content 500 spatial vary within the geographic area. The water surface elevation data of content 500 includes lowest and highest forecast water levels represented by designators 502 and 514, respectively. In FIG. 5, the forecast water levels represented by the water surface elevation data of content 500 increase between lowest forecast water level 502 and highest forecast water level 514. For example, a forecast water level represented by designator 508 may have a height that is between respective heights of lowest forecast water level 502 and highest forecast water level 514. Between lowest forecast water level 502 and forecast water level 508, the water surface elevation data of content 500 includes a forecast water level represented by designator 504 with a height that is less than a height of a forecast water level represented by designator 506. Between forecast water level 508 and highest forecast water level 514, the water surface elevation data of content 500 includes a forecast water level represented by designator 510 with a height that is less than a height of a forecast water level represented by designator 512. FIG. 5 also shows that the forecast water levels represented by water surface elevation data of content 500 may spatially vary within the geographic area in a non-continuous manner. For example, forecast water level 508 separates one portion of forecast water level 510 from other portions of forecast water level 510 in FIG. 5.

As described above, forecasts generated by static models for a compound flood event generally provide a snapshot of the compound flood event. In contrast, forecasts generated by dynamic models for a compound flood event such as the forecast water levels represented by the water surface elevation data generated by inundation model 112 have temporal variance that captures evolution of the compound flood event over time. Generating forecasts for compound flood events with temporal variance to capture evolution of the compound flood event over time involves dynamically driving models with input data that represents different flood drivers as transient conditions.

For example, inundation model 112 may analyze the input forecast data and/or observation data as time series signals to generate water surface elevation data for a defined forecast period (e.g., 12-hour forecast period, 24-hour forecast period, etc.) at one or more defined forecast intervals (e.g., 1-hour forecast intervals, 3-hour forecast intervals, etc.). Each defined forecast interval generally represents a different time of a defined forecast period. In this example, the water surface elevation data that inundation model 112 generates at each defined forecast interval of the defined forecast period may be based on different values of input forecast data and/or observation data. Over the defined forecast period, the water surface elevation data may be iteratively updated at each defined forecast interval to capture evolution of the compound flood event over time.

Another example, inundation model 112 may refresh or update water surface elevation data at a defined temporal resolution (e.g., a 6-hour temporal resolution that updates four times daily, an 8-hour temporal resolution that updates three times daily, etc.). In this example, at least one flood driver model among the multiple models that output the forecast data corresponding to multiple flood drivers may incorporate feedback from ongoing simulations (e.g., parallel simulations), antecedent simulations, and/or new observation data to calibrate the forecast data for its respective flood driver. At the defined temporal resolution, CFA platform 110 may provide the calibrated forecast data output by the flood driver model as input to inundation model 112. Inundation model 112 may update the water surface elevation data at the defined temporal resolution using that calibrated forecast data. The updated water surface elevation data may thereby indirectly incorporate the feedback that the flood driver model incorporated to output the calibrated forecast data. Differences in forecast data and/or observation data input to inundation model 112 between updates to the water surface elevation data may represent changing conditions associated with a given flood driver contributing to the compound flood event or changing interactions between multiple flood drivers. Such differences generally represent feedback that inundation model 112 incorporates at each update to calibrate the water surface elevation data to capture evolution of the compound flood event over time.

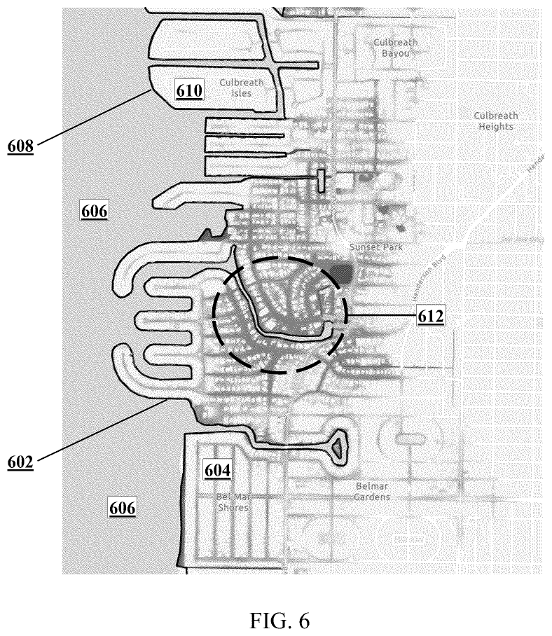

FIG. 6 illustrates example content 600 representing a map of a geographic area with hazard data, in accordance with aspects of the present disclosure. Content 600 generally includes a basemap or reference map of the geographic area to provide spatial context. For example, the basemap included in content 600 may be implemented using the basemap included in content 200 of FIG. 2 and/or layer 302 in content 300 of FIG. 3. Content 600 also includes labels associated with distinct features of the geographic area to provide additional spatial context. For example, content 600 includes labels associated with different neighborhoods in the Tampa Bay area, such as Culbreath Isles, Culbreath Bayou, Culbreath Heights, Sunset Park, Belmar Gardens, and Bel Mar Shores. Another example, content 600 also includes labels associated with different thoroughfares in the Tampa Bay area, such as Southwest Shore Boulevard and Henderson Boulevard. Content 600 further includes hazard data generated by inundation model 112 implementing a time-dependent simulation of a compound flood event. Hazard data generally represents forecast water levels within inland regions of the geographic area for the compound flood event that are expressed in terms of height above a ground surface topography.

As described above with reference to FIG. 5, inundation model 112 generates water surface elevation data for a compound flood event that generally represents forecast water levels within a geographic area for the compound flood event. As shown by FIG. 5, the water surface elevation data in content 500 represents forecast water levels in both inland regions and offshore regions of the geographic area in content 500. CFA platform 110 implements a masking or clipping operation to generate a subset of the water surface elevation data that excludes portions of the water surface elevation data that represent forecast water levels in offshore regions of a geographic area. Implementing the masking operation generally involves defining one or more boundaries that delineate between inland regions and offshore regions of a geographic area.

With reference to FIG. 6, content 600 includes a boundary 602 that delineates between inland region 604 and offshore region 606 of the geographic area in content 600. Content 600 also includes a boundary 608 that delineates between inland region 610 and offshore region 606 of the geographic area in content 600. Implementing a masking operation using boundaries 602 and 608 generates a subset of water surface elevation data that represents forecast water levels within inland regions (e.g., inland regions 604 and 610) of the geographic area in content 600. Forecast water levels represented by the subset of water surface elevation data generated by implementing that masking operation are expressed in terms of height above a vertical datum (e.g., NAVD88). Such forecast water levels are not expressed in terms of height above a ground surface topography.

As described above with reference to FIG. 4, CFA platform 110 assigns values of ground surface elevation data to elements or nodes of a mesh representation (e.g., mesh representation 400) of a geographic area generated in a simulation domain of a model. The values of ground surface elevation data that CFA platform 110 assigns to elements or nodes of the mesh representation generally correspond to both inland regions and offshore regions of the geographic area. CFA platform 110 implements a masking or clipping operation to generate a subset of the ground surface elevation data that excludes portions of the ground surface elevation data that represents ground surface bathymetry in offshore regions of the geographic area. For example, CFA platform 110 may implement the masking operation using boundaries 602 and 608 to generates a subset of ground surface elevation data that represents ground surface topography in inland regions (e.g., inland regions 604 and 610) of the geographic area in content 600. Ground surface topography represented by the subset of ground surface elevation data generated by implementing that masking operation are expressed in terms of height relative to a vertical datum (e.g., NAVD88).

A difference between the subset of ground surface elevation data and the subset of water surface elevation data may represent forecast water levels within inland regions of the geographic area in content 600 expressed in terms of height above a ground surface topography—or hazard data. Inundation model 112 or post-processing service 118 may implement a subtraction operation using the subset of ground surface elevation data and the subset of water surface elevation data to generate hazard data for the geographic area in content 600 over a forecast period. FIG. 6 depicts the hazard data that inundation model 112 generates as the darker portions of inland region 604 such as portion 612. Outer edges that bound the darker portions of inland region 604 define an inundation periphery of the hazard data generated by inundation model 112 at a given time or given forecast interval of the forecast period.

In one implementation, the inundation periphery depicted by FIG. 6 is an intermediate inundation periphery that characterizes a spatial extent of inundation within inland region 604 during an expansion phase or a receding phase of the compound flood event. For example, hazard data may include an inundation periphery that enlarges a spatial extent of inundation within a geographic area between successive forecast intervals of the hazard data during an expansion phase of a compound flood event to track rising water levels. Another example, hazard data may include an inundation periphery that contracts a spatial extent of inundation within a geographic area between successive forecast intervals of the hazard data during a receding phase of a compound flood event to track decreasing water levels. In one implementation, the inundation periphery depicted by FIG. 6 is a peak inundation periphery that characterizes a maximum spatial extent of inundation within inland region 604 as the compound flood event transitions between the expansion phase and the receding phase of the compound flood event.

FIG. 7 illustrates example content 700 representing a map of a geographic area with impact data, in accordance with aspects of the present disclosure. Content 700 generally includes a basemap or reference map of the geographic area to provide spatial context. For example, the basemap included in content 700 may be implemented using the basemap included in content 200 of FIG. 2 and/or layer 302 in content 300 of FIG. 3. Content 700 also includes labels associated with distinct features of the geographic area to provide additional spatial context. For example, content 600 includes labels associated with different neighborhoods in the Tampa Bay area such as Riviera Bay. Another example, content 700 also includes labels associated with different thoroughfares in the Tampa Bay area, such as Patica Road North East, 83^{rd} Avenue North, and U.S. Highway 92. Content 700 further includes hazard data generated by inundation model 112 implementing a time-dependent simulation of a compound flood event. For example, the hazard data included in content 700 may be implemented using the hazard data included in content 600.

Content 700 also includes impact data output by outcome model 114 implementing a time-dependent simulation of a compound flood event. Impact data generally represents forecast adverse effects of a compound flood event within a geographic area that are expressed in terms of asset degradation, debris accrual, and/or recovery time. The forecast adverse effects represented by impact data are provided at asset-level. For example, content 700 includes asset-level impact data for specific building assets of the geographic area such as building asset 702. Another example, content 700 includes asset-level impact data for specific thoroughfare assets of the geographic area such as thoroughfare asset 704, which is associated in FIG. 7 with a label that recites Tallahassee Dr NE. By including both hazard data and impact data of the compound flood event, content 700 provides an example of concurrently presenting both a forecast extent of inundation in the geographic area and forecast adverse effects at asset-level associated with the forecast extent of inundation.

CFA platform 110 may provide hazard data generated by inundation model 112 as input to dynamically drive outcome model 114. As described above with reference to FIG. 6, the hazard data includes an inundation periphery that characterizes a spatial extent of inundation within inland regions of a geographic area for a compound flood event over a forecast period. Inundation model 112 iteratively updates the inundation periphery at each forecast interval of the forecast period to capture evolution of the compound flood event over time. FIG. 7 depicts the hazard data that inundation model 112 generates as the darker portions of the geographic area in content 700 such as portion 706. Outer edges that bound the darker portions of the geographic area in content 700 define an inundation periphery of the hazard data generated by inundation model 112 at a given time or given forecast interval of the forecast period.

CFA platform 110 may also retrieve structure data from asset inventory database 116 and provide the structure data as input to dynamically drive outcome model 114. As described above with reference to FIG. 1, structure data generally characterizes attributes of assets, such as asset type (e.g., building-type asset, thoroughfare-type asset, infrastructure-type asset, and the like), location data (e.g., address, building footprint, geographic coordinates, etc.) relative to a local or geocentric horizontal geodetic datum, and elevation data (e.g., first floor height) in terms of height above a ground surface topography. Location data and/or elevation data of asset inventory database 116 generally provide spatial context for a particular asset in asset inventory database 116 within a geographic coordinate system (e.g., a dataset-specific geographic coordinate system and/or a common or local geographic coordinate system) of the geographic domain. CFA platform 110 may convert location data and/or elevation data within the structure data from the geographic domain into a simulation domain of outcome model 114 using one or more simulation transformations.

Outcome model 114 generates impact data by analyzing hazard data generated by inundation model 112 and structure data provided by CFA platform 110 to identify one or more assets impacted by inundation related to the compound flood event. For ease of reference, an asset impacted by inundation related to a compound flood event is described herein as an “impacted asset”. Alternatively, an asset unimpacted by inundation related to a compound flood event is described herein as an “unimpacted asset”. Identifying impacted assets generally involves outcome model 114 evaluating a geospatial relationship between a given asset and an inundation periphery over a forecast period of the hazard data. Outcome model 114 evaluates the geospatial relationship using location data and/or elevation data of the given asset in the structure data provided by CFA platform 110. Outcome model 114 identifies the given asset as an impacted asset when the geospatial relationship indicates spatial overlap between the given asset and the hazard data during at least one forecast interval of the forecast period. Output model 114 identifies the given asset as an unimpacted asset when the geospatial relationship lacks any indication of such spatial overlap.

The geospatial relationship indicates such spatial overlap when the inundation periphery and the location data of the given asset intersect during at least one forecast interval. For example, spatial overlap between a building asset (e.g., building asset 702) and hazard data may involve intersection between an inundation periphery of the hazard data and a building footprint of the building asset for at least one forecast interval of the hazard data. The geospatial relationship indicates such spatial overlap when the hazard data represents a forecast water level that substantially equals or exceeds the elevation data of the given asset during at least one forecast interval. For example, spatial overlap between a building asset (e.g., building asset 702) and hazard data may involve the hazard data representing a forecast water level that substantially equals or exceeds a first-floor height of the building asset. Some building assets may have a first-floor height or base flood elevation that generally corresponds to a local height of ground surface topography. Other building assets may have a first-floor height that is elevated with respect to a local height of ground surface topography. For example, a beach house in a coastal region may include structures (e.g., concrete beams, stilts, and the like) that elevate a first-floor height of the beach house with respect to a local height of ground surface topography. In one implementation, spatial overlap exists between the given asset and the hazard data when both the inundation periphery intersects with the location data of the given asset and the hazard data represents a forecast water level that substantially equals or exceeds the elevation data of the given asset during at least one forecast interval.

Impact data generated by outcome model 114 evaluating a geospatial relationship between each asset of the geographic area in content 700 and an inundation periphery for spatial overlap facilitates binary classification of each asset in content 700. For example, each asset in content 700 may be classified as either an impacted asset or an unimpacted asset using such impact data. However, FIG. 7 depicts non-binary classification of each asset in content 700 that distinguishes between impacted assets in terms of impact degree. In FIG. 7, building assets in portion 708 of content 700 or building asset 710 may represent unimpacted building assets. Building assets 702, 712, and 714 may each represent impacted building assets in FIG. 7 with different impact degrees. For example, building asset 712 represents an impacted building asset with a higher impact degree than building asset 702. That is, impact data generated by outcome model 114 predicts that inundation related to the compound flood event will impact building asset 712 more than building asset 702. Another example, building asset 714 represents an impacted building asset with a lower impact degree than building asset 702. That is, impact data generated by outcome model 114 predicts that inundation related to the compound flood event will impact building asset 714 less than building asset 702.

To facilitate non-binary classification of each asset in content 700, outcome model 114 generates impact data by evaluating a duration of spatial overlap between each asset of the geographic area in content 700 and hazard data (e.g., an inundation periphery) generated by inundation model 112. A duration of spatial overlap—or “temporal overlap”—between each asset of a geographic area and hazard data generated by inundation model 112 includes an expansion time and a receding time. An expansion time generally corresponds with an expansion phase of a compound flood event characterized by rising water levels. A receding time generally corresponds with an receding phase of a compound flood event characterized by decreasing water levels. Evaluating temporal overlap may involve outcome model 114 determining a maximum water level or peak water depth associated with location data of a given asset between an expansion time and a receding time of the temporal overlap. Evaluating temporal overlap may also involve outcome model 114 determining a magnitude of the temporal overlap associated with location data of a given asset or a difference between an expansion time and a receding time of the temporal overlap. A magnitude of temporal overlap associated with location data of a given asset generally characterizes how long the given asset remains subject to inundation related to a compound flood event.

Generating impact data for each impacted asset involves outcome model 114 providing a maximum water level and/or a magnitude of temporal overlap associated with location data of the impacted asset as input to a hazard damage function. Generating impact data for each impacted asset also involves outcome model 114 providing structure data retrieved from asset inventory database 116 that characterizes one or more attributes of the impacted asset as input to a hazard damage function. Based on such inputs, a hazard damage function outputs impact data for each impacted asset that estimates various damages associated with inundation related to a compound flood event, as described in greater detail below with reference to FIG. 8. Responsive to inundation model 112 iteratively updating hazard data at each defined forecast interval, outcome model 114 iteratively updates impact data for each impacted asset to capture evolution of the impact data over time. In one implementation, CFA platform 110 retrieves the hazard damage function from a Hazus dataset maintained by FEMA.

In one implementation, CFA platform 110 implements a filtering, masking, or clipping operation on the structure data to generate a subset of the structure data that excludes portions of the structure data. Implementing the filtering operation to exclude portions of the structure data may increase processing speed and/or forecasting accuracy by driving a model with input data that is more locally relevant. In one implementation, CFA platform 110 implements the filtering operation on the structure data using a defined AoI to generate a subset of the structure data that excludes portions of the structure data associated with assets positioned external to the defined AoI. In one implementation, a view of the map represented by content 700 may define the AoI. In one implementation, a polygon shape (e.g., polygon shape 202 of FIG. 2) may define the AoI.

In one implementation, CFA platform 110 implements the filtering operation on the structure data using a defined asset subset to generate a subset of the structure data that excludes portions of the structure data associated with assets external to the defined asset subset. In one implementation, user input received by post-processing service 118 via a user input mechanism such as a graphical user interface (e.g., dashboard 800 of FIG. 8) may define the asset subset. In one implementation, the user input received by post-processing service 118 may define the asset subset using one or more attributes in the structure data, such as location data, asset-type, asset-subtype, and the like. In one implementation, the asset subset includes a single asset (e.g., a single building or a single thoroughfare). In one implementation, the asset subset includes multiple assets, such as two or more assets with a common location (e.g., zip code, geographic coordinate range, neighborhood, and the like) in the geographic area, asset-type, asset-subtype, and the like.

FIG. 8 illustrates an example graphical user interface with content representing a map of a geographic area, in accordance with aspects of the present disclosure. In this example, the graphical user interface is a dashboard 800 generated by post-processing service 118 for presentation on a display associated with an electronic device (e.g., CPA platform 110 and/or client device 130). Dashboard 800 includes various cards or panels that each present different information regarding a compound flood event. In FIG. 8, dashboard 800 includes a map card 802 that post-processing service 118 populates with content representing a map of a geographic area. The content of map card 802 may be implemented using any combination of content 200, content 300, content 500, content 600, and content 700 described above with reference to FIG. 2, FIG. 3, FIG. 5, FIG. 6, and FIG. 7, respectively. The content of map card 802 generally includes a basemap or reference map of the geographic area to provide spatial context. The content of map card 802 also includes labels associated with distinct features of the geographic area to provide additional spatial context. For example, the content of map card 802 includes a label that recites Renaissance Vinoy Golf Club and labels associated with different thoroughfares in the geographic area, such as Locust Street North East and Cherry Street North East.

The content of map card 802 also includes hazard data generated by inundation model 112 implementing a time-dependent simulation of the compound flood event. As described above with reference to FIG. 6, outer edges that bound darker portions of inland regions within the geographic area of map card 802 define an inundation periphery (e.g., an intermediate inundation periphery or a peak inundation periphery) of the hazard data generated by inundation model 112 at a given time or given forecast interval of a forecast period. The content of map card 802 also includes impact data output by outcome model 114 implementing a time-dependent simulation of the compound flood event. As described above with reference to FIG. 7, the forecast adverse effects represented by the impact data output by outcome model 114 are provided at asset-level. In FIG. 8, the impact data within the content of map card 802 includes asset-level impact data for specific building assets and specific thoroughfare assets. By including both hazard data and impact data of the compound flood event, the content of map card 802 provides an example of concurrently presenting both a forecast extent of inundation in the geographic area and forecast adverse effects at asset-level associated with the forecast extent of inundation.

Dashboard 800 also includes a number of impact cards that each present different impact data for an AoI within the geographic area or AoI-level impact data. AoI-level impact data generally provides a cumulative summation of asset-level impact data for a defined AoI at a forecast interval that corresponds with a forecast interval of hazard data included in the content of map card 802. Post-processing service 118 aggregates a defined subset of asset-level impact data output by outcome model 114 to generate AoI-level impact data. A subset of asset-level impact data may be defined in terms of asset attributes (e.g., asset-type, asset-subtype, construction material, and other distinguishing attributes of assets), damage-type (e.g., number of impacted assets, asset availability reduction, reconstruction costs, generated debris, recovery time, physical damage quantity or percentage, and other distinct forms of damage), or a combination thereof.

Impact card 804 includes AoI-level impact data that provides a cummulative summation of a number of impacted building-type assets within the AoI of the geographic area. Impact card 806 includes AoI-level impact data that provides a cummulative summation of reconstruction costs for impacted building-type assets within the AoI of the geographic area. Impact card 808 includes AoI-level impact data that provides a cummulative summation of asset availability reduction for thoroughfare-type assets such as miles of unavailable thoroughfares within the AoI of the geographic area. Impact card 810 includes AoI-level impact data that provides a cummulative summation of generated debris associated with all impacted assets within the AoI of the geographic area. In this example, dashboard 800 includes four impact cards, such as impact cards 804, 806, 808, and 810. In other examples, dashboard 800 may be implemented with a higher number (e.g., five) or a lower number (e.g., three) of impact cards. In this example, each impact card of dashboard 800 includes AoI-level impact data. In other examples, dashboard 800 may include one or more impact cards that include asset-level impact data.

Dashboard 800 further includes a hazard card 812 that presents hazard data for an AoI within the geographic area or AoI-level hazard data. Hazard card 812 includes a time-series graph that plots AoI-level hazard data at each forecast interval over a forecast period that corresponds with a forecast period of hazard data included in the content of map card 802. In one implementation, one or more of map card 802 and hazard card 812 provides a visible indication of a forecast peak inundation periphery and an estimated time of the forecast peak inundation periphery.

In FIG. 8, post-processing service 118 populated hazard card 812 with forecast hazard data for a particular physical sensor (e.g., sensor 125 or sensor 128) associated with environmental monitor 120, such as sensor 125 or sensor 128. In one implementation, post-processing service 118 may retrieve the forecast hazard data from environmental monitor 120. In one implementation, post-processing service 118 may retrieve the forecast hazard data from forecast/nowcast database 142. FIG. 8 depicts the AoI hazard data that hazard card 812 presents as a forecast water level for a National Oceanic and Atmospheric Administration (NOAA) sensor at Saint Peter Station with a station identifier of 8726520 over a forecast period that includes 12 pm or noon on August 28^{th} and 12 am or midnight on August 31^{st}. Post-processing service 118 selected that particular physical sensor for populating hazard card 812 with forecast hazard data from the various physcial sensors associated with environmental monitor 120 based on proximity between the particular physical sensor and the AoI.

While FIG. 8 depicts hazard card 812 presenting forecast hazard data for a particular physical sensor, post-processing service 118 may populate hazard card 812 with forecast hazard data for a simulated sensor in other implementations. Populating hazard card 812 with forecast hazard data for a simulated sensor generally involves post-processing service 118 determining a location for the simulated sensor within an AoI of the geographic area. For example, post-processing service 118 may determine a central location within the AoI for the simulated sensor. Populating hazard card 812 with forecast hazard data for a simulated sensor also involves post-processing service 118 interpolating or extrapolating forecast hazard data for the simulated sensor using forecast hazard data for one or more physical sensors associated with environmental monitor 120. For example, post-processing service 118 may identify one or more physical sensors associated with environmental monitor 120 that are located within a defined proximity of the determined location for the simulated sensor. In this example, post-processing service 118 may interpolate or extrapolate forecast data for the simulated sensor using forecast hazard data for the one or more identified physical sensors.

Post-processing service 118 may receive user input via dashboard 800 to control information presented on dashboard 800 and/or time-dependent simulations implemented by one or more of inundation model 112 and outcome model 114. For example, the AoI may be defined by a view of the map represented by the content of map card 802 or by a polygon shape (e.g., polygon shape 202 of FIG. 2), as described above with reference to FIG. 2. Another example, post-processing service 118 may receive user input via dashboard 800 that selects a particular asset within the content of map card 802. In this example, post-processing service 118 may update one or more impact cards (e.g., impact cards 804, 806, 808, and 810) of dashboard 800 to present asset-level impact data for the particular asset selected by the user input. In this example, post-processing service 118 may also update hazard card 812 to present asset-level hazard data for the particular asset selected by the user input.

Another example, post-processing service 118 may receive user input via dashboard 800 that selects a particular time (e.g., forecast interval of a forecast period in hazard card 812) or particular time range (e.g., a subset of a forecast period in hazard card 812 or the forecast period in its entirety). In this example, post-processing service 118 may update the content of map card 802 to concurrently present hazard data and impact data for the particular time or the particular time range selected by the user input. In one implementation, post-processing service 118 may update the content of map card 802 to concurrently present hazard data and impact data for the particular time selected by the user input as image data (e.g., a single image). In one implementation, post-processing service 118 may update the content of map card 802 to concurrently present hazard data and impact data for the particular time range selected by the user input as video data (e.g., a sequence of images).

While the foregoing implementation describes user input being received via dashboard 800, post-processing service 118 may receive user input via other user input mechanisms associated with the electronic device in other implementations. Examples of such other user input mechanisms associated with the electronic device include physical input mechanisms (e.g., a mouse, a physical keyboard, a joystick, a knob, and the like), simulated input mechanisms (e.g., a softkey, a virtual keyboard, and the like), or a combination thereof.

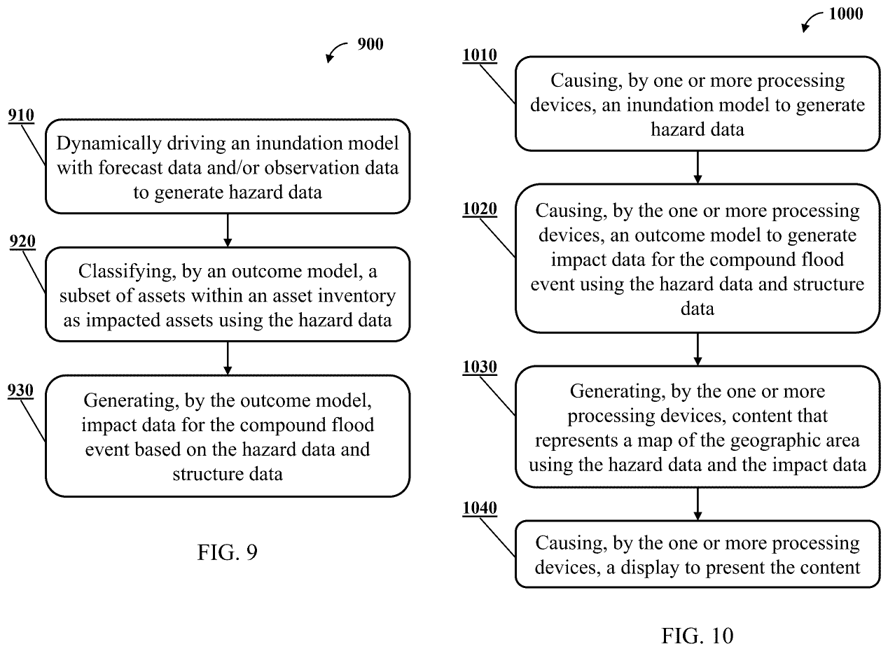

With the foregoing in mind, FIGS. 9 and 10 are flow diagrams of example, non-limiting computer-implemented methods of compound flood event impact forecasting, in accordance with one or more embodiments described herein. Repetitive description of like elements employed in other embodiments described herein is omitted for sake of brevity. Method 900 of FIG. 9 and/or method 1000 of FIG. 10 may be performed by CFA platform 110 described above with reference to FIG. 1 or any other suitable system implemented as program code or processor-executable instructions on one or more computer devices. Furthermore, steps or operations of method 900 and/or method 1000 may be performed in the order disclosed herein or in any other suitable order. For example, certain steps or operations of methods 900 and/or method 1000 may be performed concurrently. In addition, in certain embodiments, at least one step or operation of method 900 and/or method 1000 may be omitted.

With reference to FIG. 9, at 910, method 900 comprises dynamically driving an inundation model (e.g., inundation model 112) with forecast data to generate hazard data. The hazard data characterizes inundation of a geographic area by a compound flood event induced by multiple flood mechanisms. The forecast data dynamically driving the inundation model may be output by a plurality of models (e.g., models 123 and 126). Each model of the plurality of models may be configured to simulate a process corresponding to a different flood mechanism among the multiple flood mechanisms. For example, models 123 and 126 are configured to simulate a process corresponding to a first flood mechanism and a process corresponding to a second flood mechanism, respectively.

In one implementation, the plurality of models includes first and second models. In one implementation, the forecast data includes calibrated forecast data from the first model that incorporates feedback from a parallel simulation of the second model. In one implementation, method 900 can further comprise, dynamically driving the inundation model with observation data to generate the hazard data. The observation data dynamically driving the inundation model may be output one or more sensors (e.g., sensors 125 and/or 128).

At 920, method 900 comprises classifying, by an outcome model (e.g., outcome model 114), a subset of assets within an asset inventory (e.g., asset inventory 116) as impacted assets using the hazard data. In one implementation, classifying the subset of assets within the asset inventory as impacted assets further comprises, evaluating, by the outcome model, a geospatial relationship between a given asset within the asset inventory and an inundation periphery over a forecast period of the hazard data. In one implementation, the outcome model implements a Hazus flood model methodology.

At 930, method 900 comprises generating, by the outcome model, impact data for the compound flood event based on the hazard data and structure data. The structure data characterizes attributes of the impacted assets. In one implementation, generating the impact data for the compound flood event further comprises, estimating, by the outcome model, an impact degree for a given impacted asset based on a temporal overlap between the given asset and the hazard data.

In one implementation, method 900 can further comprise, controlling an extent of a simulation domain of the outcome model using an AoI (e.g., an AoI defined by a view of the map represented by content 200, an AoI defined by polygon shape 202 in content 200, and/or an AoI defined using geographic coordinate values) user input. In one implementation, method 900 can further comprise, controlling an extent of a simulation domain of the inundation model using an AoI defined by user input. In one implementation, the extent of the simulation domain of the inundation model and the extent of the simulation domain of the outcome model are each controlled using the same AoI.

In one implementation, method 900 can further comprise, configuring the outcome model for time-dependent simulation such that the impact data adapts to changing conditions of the compound flood event over time. In one implementation, method 900 can further comprise, iteratively updating the impact data generated by the outcome model at each defined forecast interval of a defined forecast period to capture evolution of the compound flood event over time. In one implementation, the impact data comprises AoI-level impact data and method 900 can further comprise, for an AoI defined by user input, providing a cumulative summation of asset-level impact data for the AoI at a given forecast interval of the hazard data.

In one implementation, method 900 can further comprise, parameterizing a mesh representation for time-dependent simulation by the outcome model using a simulation transformation that defines a conversion between coordinates in a geographic coordinate system of the geographic area and coordinates in a simulation coordinate system of a simulation domain of the outcome model. In one implementation, method 900 can further comprise, configuring different boundaries in a simulation domain of the inundation model to receive different input data related to different flood mechanisms among the multiple flood mechanisms.

With reference to FIG. 10, at 1010, method 1000 comprises causing, by one or more processing devices (e.g., one or more processing devices of CFA platform 110), an inundation model (e.g., inundation model 112) to generate hazard data. The hazard data characterizes inundation of a geographic area by a compound flood event induced by multiple flood mechanisms using input data that represents the multiple flood mechanisms as transient conditions. At 1020, method 1000 comprises causing, by the one or more processing devices, an outcome model (e.g., outcome model 114) to generate impact data for the compound flood event using the hazard data and structure data. The structure data characterizes attributes of assets within the geographic area.

At 1030, method 1000 comprises generating, by the one or more processing devices, content (e.g., content 200, 300, 500, 600, and/or 700) that represents a map of the geographic area using the hazard data and the impact data. In one implementation, the content includes a forecast peak inundation periphery and an estimated time of the forecast peak inundation periphery. At 1040, method 1000 comprises causing, by the one or more processing devices, a display to present the content. The display may be operatively coupled to the one or more processing devices.

In one implementation, generating the content further comprises, converting respective coordinates of different layers of the content into a common geographic coordinate system using a spatial transformation to preserve a geospatial relationship between the different layers of the content. In one implementation, generating the content further comprises, associating the hazard data and the impact data with different layers (e.g., layers 302, 304, 306, and/or 308) of the content to concurrently present a forecast extent of the inundation in the geographic area for the compound flood event and forecast adverse effects associated with the forecast extent of the inundation at an asset-level. In one implementation, generating the content further comprises, iteratively updating the impact data in the content at each defined forecast interval of a defined forecast period to capture evolution of the compound flood event over time.

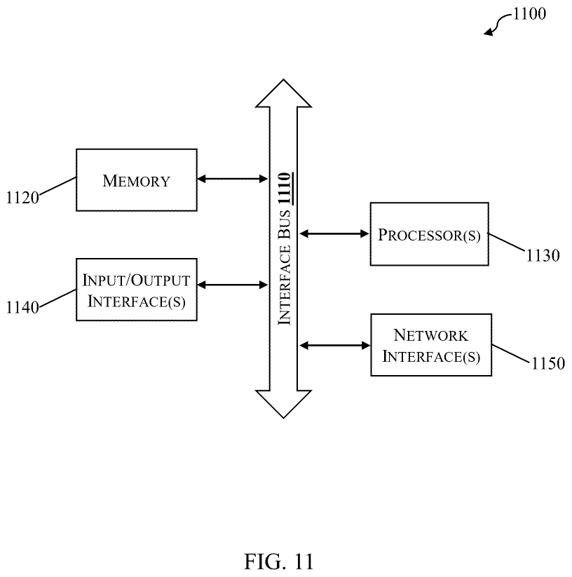

FIG. 11 is a block diagram that illustrates an example computer system, generally designated 1100, for implementing aspects of the present disclosure. As used herein, the phrase “computer system” generally refers to a dedicated computing device with processing power and storage memory, which supports operating software that underlies the execution of software, applications, and computer programs thereon. With reference to FIG. 1 and FIG. 3, CFA platform 110, environmental monitor 120, client device 130, asset inventory database 116, forecast/nowcast database 142, observation database 144, geospatial database 146, elevation dataset 310, building dataset 312, and/or thoroughfare dataset 314 may be implemented on one or more computer devices or systems, such as computer system 1100. Computer system 1100 includes bus 1110 that directly or indirectly couples the following components: memory 1120, a processor 1130, input/output (I/O) interface 1140, and network interface 1150. Bus 1110 is configured to communicate, transmit, and transfer data, controls, and commands between the various components of computer system 1100.

Memory 1120 may include a single memory device or a plurality of memory devices including, but not limited to, read-only memory (ROM), random access memory (RAM), volatile memory, non-volatile memory, static random-access memory (SRAM), dynamic random-access memory (DRAM), flash memory, cache memory, or any other device capable of storing information or data. Memory 1120 may also include data storage devices such as a hard drive, optical drive, tape drive, non-volatile solid-state device, or any other device capable of storing information or data.

Processor 1130 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 1120. For purposes of the present disclosure, “processor” refers to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein.

I/O interface 1140 is configured to coordinate I/O traffic between memory 1120, processor 1130, network interface 1150, and any combination of input devices and output devices. Network interface 1150 enables computer system 1100 to exchange data with other computing devices via any suitable network. In a networked environment, program modules depicted relative to computer system 1100, or portions thereof, may be stored in a remote memory storage device accessible via network interface 1150. It will be appreciated that the network connections shown are exemplary and other means of establishing a communications link between the computers may be used.

In general, aspects of the present disclosure may be embodied in, and fully or partially automated by, code modules executed by one or more computers or computer processors. The code modules executed to implement aspects of the present disclosure, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the present disclosure. Computer-readable instructions for carrying out operations that implement aspects of the present disclosure may be, for example, assembly language or either source code or object code written in any combination of one or more programming languages.

Program code for implementing aspects of the present disclosure may be stored on or transmitted across some form of computer-readable media. The computer-readable media may include a variety of media that may be accessed by computer system 1100. By way of example, and not limitation, computer-readable media may include computer-readable storage media and computer-readable signal media. For purposes of the present disclosure, “computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

For purposes of the present disclosure, “computer-readable signal media” refers to a signal-bearing medium that is configured to transmit instructions to the hardware of computer system 1100, such as via a network. Signal media typically may embody computer-readable instructions, data structures, program modules, or other data in a modulated data signal, such as carrier waves, data signals, or other transport mechanisms. Signal media also include any information delivery media. For purposes of the present disclosure, “modulated data signal” refers to a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Various aspects of the present disclosure may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

What is claimed is:

1. A computer-implemented method, comprising:
dynamically driving an inundation model with forecast data to generate hazard data that characterizes inundation of a geographic area by a compound flood event induced by multiple flood mechanisms, the forecast data output by a plurality of models, and each model of the plurality of models configured to simulate a process corresponding to a different flood mechanism among the multiple flood mechanisms;
classifying, by an outcome model, a subset of assets within an asset inventory as impacted assets using the hazard data; and
generating, by the outcome model, impact data for the compound flood event based on the hazard data and structure data that characterizes attributes of the impacted assets.

2. The computer-implemented method of claim 1, further comprising:
controlling an extent of a simulation domain of the outcome model using an area of interest (AoI) defined by user input.

3. The computer-implemented method of claim 2, further comprising:
controlling an extent of a simulation domain of the inundation model using the AoI defined by the user input.

4. The computer-implemented method of claim 1, further comprising:
configuring the outcome model for time-dependent simulation such that the impact data adapts to changing conditions of the compound flood event over time.

5. The computer-implemented method of claim 1, further comprising:
iteratively updating the impact data at each defined forecast interval of a defined forecast period to capture evolution of the compound flood event over time.

6. The computer-implemented method of claim 1, wherein classifying the subset of assets within the asset inventory as impacted assets further comprises, evaluating, by the outcome model, a geospatial relationship between a given asset within the asset inventory and an inundation periphery over a forecast period of the hazard data.

7. The computer-implemented method of claim 1, wherein generating the impact data for the compound flood event further comprises, estimating, by the outcome model, an impact degree for a given impacted asset based on a temporal overlap between the given asset and the hazard data.

8. The computer-implemented method of claim 1, wherein, for an area of interest (AoI) defined by user input, the impact data comprises AoI-level impact data providing a cumulative summation of asset-level impact data for the AoI at a given forecast interval of the hazard data.

9. The computer-implemented method of claim 1, further comprising:
parameterizing a mesh representation for time-dependent simulation by the outcome model using a simulation transformation that defines a conversion between coordinates in a geographic coordinate system of the geographic area and coordinates in a simulation coordinate system of a simulation domain of the outcome model.

10. The computer-implemented method of claim 1, wherein the plurality of models includes first and second models, and the forecast data includes calibrated forecast data from the first model that incorporates feedback from a parallel simulation of the second model.

11. The computer-implemented method of claim 1, wherein the outcome model implements a Hazus flood model methodology.

12. A non-transitory computer-readable medium having program code that is stored thereon, the program code executable by one or more processing devices for performing operations comprising:
causing an inundation model to generate hazard data that characterizes inundation of a geographic area by a compound flood event induced by multiple flood mechanisms using input data that represents the multiple flood mechanisms as transient conditions;
causing an outcome model to generate impact data for the compound flood event using the hazard data and structure data that characterizes attributes of assets within the geographic area;
generating content that represents a map of the geographic area using the hazard data and the impact data; and
causing a display to present the content, wherein the display is operatively coupled to the one or more processing devices.

13. The non-transitory computer readable medium of claim 12, wherein generating the content comprises:
converting respective coordinates of different layers of the content into a common geographic coordinate system using a spatial transformation to preserve a geospatial relationship between the different layers of the content.

14. The non-transitory computer readable medium of claim 12, wherein generating the content comprises:
associating the hazard data and the impact data with different layers of the content to concurrently present a forecast extent of the inundation in the geographic area for the compound flood event and forecast adverse effects associated with the forecast extent of the inundation at an asset-level.

15. The non-transitory computer readable medium of claim 12, wherein generating the content comprises:
iteratively updating the impact data in the content at each defined forecast interval of a defined forecast period to capture evolution of the compound flood event over time.

16. The non-transitory computer readable medium of claim 12, wherein the content includes a forecast peak inundation periphery and an estimated time of the forecast peak inundation periphery.

17. A system, comprising:
a memory that stores computer-executable components; and
a processor that executes the computer-executable components stored in the memory, wherein the computer-executable components comprise:
an inundation model that generates hazard data using input data corresponding to multiple flood mechanisms, wherein the hazard data characterizes inundation of a geographic area by a compound flooding event induced by the multiple flood mechanisms;
an impact model that generates impact data for the compound flood event using the hazard data and structure data that characterizes attributes of assets within the geographic area; and
a post-processing service that generates content that represents a map of the geographic area using the hazard data and the impact data, wherein different layers of the content reference different datasets that express spatial locations differently.

18. The system of claim 17, wherein the inundation model further updates the hazard data at a defined temporal resolution using calibrated forecasted data to capture evolution of the compound flood event over time.

19. The system of claim 17, wherein the post-processing service further receives user input that defines an area of interest (AoI) within the geographic area that controls an extent of a simulation domain of the outcome model.

20. The system of claim 17, wherein the computer-executable components further comprise a push-based interface with a source of stream data corresponding to a layer of the content, and the input data comprising the stream data.
